(19) United States
(12) Patent Application Publication
(10) Pub. No.: US 2023/0145797 A1
(43) Pub. Date: May 11, 2023

(54) FACILITATING MULTIPLE STEP NETWORK CONFIGURATION ACTIVATION AUTOMATION BASED ON PARALLEL PROCESSING

(71) Applicant: AT&T Intellectual Property I, L.P., Atlanta, GA (US)

(72) Inventors: Subrat Patra, Schaumburg, IL (US); Abdulla Udaipurwala, Monroe Township, NJ (US); Ivetta Pogosova, Plainsboro, NJ (US); Fen Mei, Marlboro, NJ (US)

(21) Appl. No.: 17/521,246

(22) Filed: Nov. 8, 2021

(51) Int. Cl. H04L 12/46; H04L 12/24

(52) U.S. Cl. CPC H04L 12/4641; H04L 41/0806

(57) ABSTRACT

Facilitating multiple step network configuration activation automation based on parallel processing is provided herein. Operations of a system include based on a determination that a network activation is to be implemented on target equipment, parsing the network activation into a first group of initialization portion actions and a second group of active target actions. The operations also can include implementing, via first parallel processing, the first group of initialization portion actions on the target equipment. Further, the operations can include, based on a second determination of a completion of the implementing of the first group of initialization portion actions, implementing, via second parallel processing, the second group of active target actions on the target equipment during an implementation period. The target equipment are equipment of a virtual local area network.

### TECHNICAL FIELD

This disclosure relates generally to the field of network configuration and, more specifically, to facilitating network configuration parallelization of virtual local area network equipment.

### BACKGROUND

During a configuration activation process across equipment of a network (such as virtual local area equipment of a virtual local area network (VLAN)), all the equipment is brought off-line during a “customer maintenance window. The customer maintenance window is generally scheduled during off hours (e.g., at night) and for a defined period of time (e.g., two hours). During the customer maintenance window, all activities associated with the activation process are performed manually. The activities include initial action, testing, and the actual configuration of the equipment. These activities are performed individually for each equipment, which can take a considerable amount of time. Further, if issues or problems are encountered, correction of such problems have to occur and/or the activation process might need to be reversed, which is performed individually for each equipment. Such correction and/or reversal can extend the defined period of time for the customer maintenance window, which can negatively impact a customer experience. Thus, there have been missed opportunities to upgrade or configure a network due to resource and time constraints.

Accordingly, unique challenges exist associated with network configuration activation without the lengthy configuration process experienced by existing techniques.

### BRIEF DESCRIPTION OF THE DRAWINGS

Various non-limiting embodiments are further described with reference to the accompanying drawings in which:

FIG. 1 illustrates an example, non-limiting, computer-implemented method for facilitating multiple-step network activation automation in accordance with one or more embodiments described herein;

FIG. 2 illustrates an example, non-limiting, schematic representation of activation and backout steps in accordance with one or more embodiments described herein;

FIG. 3 illustrates an example, non-limiting, representation of layers of the network controller in accordance with one or more embodiments described herein;

FIG. 4 illustrates a flow diagram of a manual activation synchronization mechanism to enable hybrid activation in accordance with one or more embodiments described herein;

FIG. 5 illustrates an example, non-limiting, system that facilitates multiple step network configuration activation automation based on parallel processing in accordance with one or more embodiments described herein;

FIG. 6 illustrates an example, non-limiting, computer-implemented method for facilitating parallel processing of initialization portions in accordance with one or more embodiments described herein;

FIG. 7 illustrates an example, non-limiting, computer-implemented method for facilitating sequential and parallel processing based on detection of collisions in accordance with one or more embodiments described herein;

FIG. 8 illustrates an example, non-limiting, computer-implemented method for resetting and/or restoring equipment during multiple step network configuration activation automation based on parallel processing in accordance with one or more embodiments described herein;

FIG. 9 illustrates an example, non-limiting, computer-implemented method for performing manual and automated procedures during multiple step network configuration activation in accordance with one or more embodiments described herein;

FIG. 10 illustrates an example, non-limiting, block diagram of a handset operable to engage in a system architecture that facilitates wireless communications according to one or more embodiments described herein; and

FIG. 11 illustrates an example, non-limiting, block diagram of a computer operable to engage in a system architecture that facilitates wireless communications according to one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular networked environment or standard).

Described herein are systems, methods, articles of manufacture, and other embodiments or implementations that can facilitate multiple step network activation automation. For example, when an entity, via a device or equipment associated with a virtual local area network (VLAN), activates a connection or circuit in the network, there could be hundreds (or more) devices in the VLAN that need to be activated. Conventionally, a manual process would go to each and every VLAN and bring it to the activation process, which includes multiple steps. This process would need to be performed multiple times (depending on the number of steps) for the hundreds of VLANs. In addition, a determination has to be made to ensure the circuit is up and running.

All these processes need to be performed during a “customer maintenance window,” which generally occurs during off hours (e.g., at night) and for a defined period of time (e.g., two hours). Since this was a manual process, many people were involved, the entire process took a long time, and was stressful. In some cases, some procedures were not performed. For example, if a port is being changed from, for example, a 1G port to a 10G port or 100G port, even though the upgrade would reduce expenses by using the higher bandwidth ports, the upgrade might not occur due to lack of capacity (e.g., personnel to manually perform the upgrade, time constraints, and so on). Thus, there have been missed opportunities to improve or upgrade a network.

The one or more embodiments provided herein automate and optimize the process. For example, the customer maintenance window is independent of the initial activation or testing. Further, parallelization is performed such that the steps are performed in parallel (e.g., horizontally) across all VLANs at a same time or substantially a same time. Further, collisions can be avoided by determining beforehand which VLANs are to be updated sequentially rather than in parallel. Thus, the VLANs that have a collision can be updated sequentially, while the other VLANs are updated in parallel. Further, the disclosed embodiments provide a reset procedure, which resets the VLANs if something is determined to be incorrect. Alternatively, or additionally, to cancel the entire process, a restore process can be implemented. Also provided herein is a hybrid activation, which facilitates both manual and automatic configuration based on synchronization through notifications between a manual process and an automatic process.

An embodiment relates to a method that includes dividing, by a system including a processor, a network configuration activation into an initialization portion and an activate target portion. The method also includes implementing, by the system, the initialization portion as parallel operations performed on equipment of a group of equipment. Further, the method includes implementing, by the system, the activate target portion on the equipment during a defined time period. Implementation of the initialization portion is performed during background processes and prior to the defined time period. Further, implementation of the initialization portion as the parallel operations is performed while the equipment are in an on-line status. In an example the group of equipment are associated with a virtual local area network.

Implementation of the initialization portion as the parallel operations can include determining an ordered list of actions associated with the initialization portion and facilitating a first performance of a first action of the ordered list of actions on the equipment at substantially a first same time. Further, based on a determination that the facilitating of the first performance is completed, the method can include facilitating a second performance of a second action of the ordered list of actions on the equipment at substantially a second same time, different than the first same time.

According to some implementations, the equipment include a first equipment and a second equipment, and the method further includes, prior to the implementing of the initialization portion as the parallel operations, determining, by the system, a virtual routing and forwarding collision exists between the first equipment and the second equipment. The method also includes performing, by the system, the initialization portion on the first equipment and the second equipment sequentially.

In some implementations, based on detection of an error associated with the first equipment, the method can include resetting, by the system, a first current configuration of the first equipment to a previous configuration, wherein the second equipment retains a second current configuration. According to some implementations, the method can include, based on detection of an error, restoring, by the system, the equipment to respective initialization portions. Further to this implementation, the respective initialization portions are respective configurations of the equipment prior to the implementing of the activate target portion.

According to some implementations, the method can include determining, by the system, that first equipment of the equipment has encountered a configuration issue. The method also can include facilitating, by the system, a manual configuration of the first equipment, wherein other equipment, excluding the first equipment, are configured via an automated configuration. Further to these implementations, the manual configuration is implemented via a first instantiation, the automated configuration is implemented via a second instantiation, and the method further includes facilitating, by the system, a first transmission of a first notification from the first instantiation to the second instantiation. A first notification includes first information indicative of the manual configuration of the first equipment. Further, in some implementations, the method can include facilitating, by the system, a second transmission of a second notification from the second instantiation to the first instantiation. The second notification includes second information indicative of the automated configuration of the other equipment.

Another embodiment relates to a system that can include a processor and a memory that stores executable instructions that, when executed by the processor, facilitate performance of operations. The operations can include, based on a determination that a network activation is to be implemented on target equipment, parsing the network activation into a first group of initialization portion actions and a second group of active target actions. The operations also can include implementing, via first parallel processing, the first group of initialization portion actions on the target equipment. Further, the operations can include, based on a second determination of a completion of the implementing of the first group of initialization portion actions, implementing, via second parallel processing, the second group of active target actions on the target equipment during an implementation period. The target equipment are equipment of a virtual local area network.

Implementation of the first group of initialization portion actions is performed during background processes and prior to the implementation period. In an example, implementation of the first group of initialization portion actions includes parallelizing bulk configurations of the first group of initialization portion actions for equipment of the target equipment for which collisions are avoided.

According to some implementations, the equipment is first equipment, and the operations include determining that collisions are expected to occur between the first equipment and second equipment of the target equipment. The operations also include performing initialization portion actions of the first group of initialization portion actions at the first equipment and the second equipment via sequential processing.

In some implementations, the operations include, based on a third determination that the implementing of the first group of initialization portion actions is to be aborted, restoring the target equipment to respective initial states. The respective initial states are respective states of equipment of the target equipment prior to the implementing of the first group of initialization portion actions.

According to some implementations, the operations can include, prior to the implementing of the second group of active target actions, performing testing of the first group of initialization portion actions during background processes and prior to the implementation period.

Another embodiment relates to a non-transitory machine-readable medium, including executable instructions that, when executed by a processor, facilitate performance of operations. The operations can include decoupling a configuration of a group of target equipment into a first group of initial events and a second group of implementation events. The operations also can include performing the first group of initial events via first parallel processing across the group of target equipment and during background processes. Further, the operations can include performing the second group of implementation events via second parallel processing across the group of target equipment and during a defined period reserved for the second group of implementation events. Performance of the first group of initial events is completed prior to the defined period. In an example, the defined period is a maintenance window, and the group of target equipment is off-line during the defined period.

The first parallel processing can include implementing a first initial event of the first group of initial events on the group of target equipment during a first time period. Further, based on a determination that the implementing the first group of initial events has finalized, the first parallel processing can include implementing a second initial event of the first group of initial events on the group of target equipment during a second time period.

By way of example and not limitation, according to a conventional process, during a customer maintenance window, all circuits are moved over manually. This takes a considerable amount of time per VLAN (e.g., can take 45 minutes or more), which hinders performance of bulk migration projects that involve an impact to end users. Thus, Network to Network Interface (NNI) Migration and Ethernet Access Tail Migration projects that need to move thousands of circuits to a large number (e.g., thousands, tens of thousands, hundreds of thousands, and so on) collectors and third-party collectors cannot reasonably be performed. The disclosed embodiments provide an automation that enables these types of migrations, which can be performed automatically and in a very short amount of time, and with reduced expense, as compared to conventional processes.

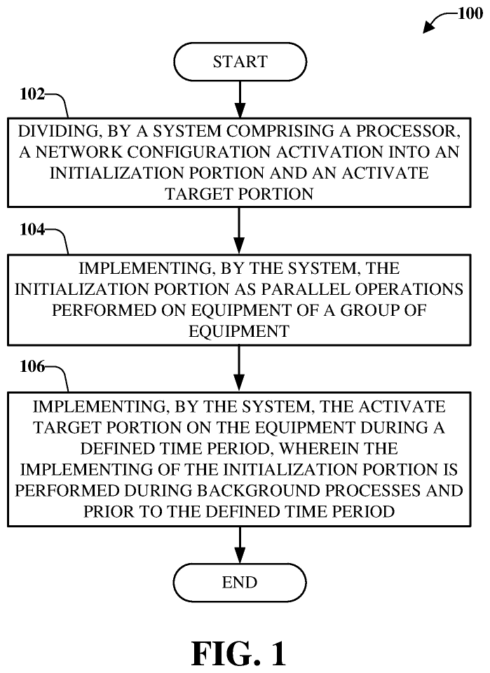

FIG. 1 illustrates an example, non-limiting, computer-implemented method 100 for facilitating multiple-step network activation automation in accordance with one or more embodiments described herein. The computer-implemented method 100 can be implemented by a system including a memory and a processor, network equipment including a memory and a processor, a network controller including a memory and a processor, or another computer-implemented device including a memory and a processor.

The computer-implemented method 100 begins, at 102, when a system including a processor divides a network configuration activation into an initialization portion and an activate target portion. For example, the initialization portion can include multiple steps and/or procedures (e.g., initial actions, testing) to be performed in order to implement an activation configuration(s) on a group of equipment. The activate target portion can be an update or configuration that is applied at the group of equipment. The group of equipment can be equipment associated with one or more VLANs. Dividing the network configuration activation can be based on one or more internal and/or external instructions that indicate the configuration activation is to be performed on the group of network equipment.

Further, at 104, the system can implement the initialization portion as parallel operations performed on equipment of a group of equipment. The initialization portion includes multiple steps and/or procedures, each of which is to be performed on the equipment in the group of equipment. Therefore, by way of example, if the initialization portion includes ten steps and the group of equipment includes 99 devices, then there is a total of 990 operations that need to be performed (10 for each device). Rather than performing steps 1-10 on a first equipment, and then performing steps 1-10 on a second equipment, and so on in a sequential manner, at 204 the individual steps are performed across all equipment, in parallel, or at about the same time. Thus, step 1 is performed on all the equipment in the group at a same time, or at substantially the same time. Upon or after step 1 is completed, step 2 is performed on all the equipment in the group at a same time, or at substantially the same time. Thereafter, step 3 can be performed across all equipment at the same time (substantially the same time), then step 4, then step 5, and so on.

Upon or after all the initialization portions are completed, at 106, the system can implement the activate target portion on the equipment during a defined time period. It is noted that implementing the initialization portion, at 104, is performed during background processes and prior to the defined time period. Thus, the initialization portion is completed before (e.g., minutes, hours, days, weeks, months, and so on) the active target process is implemented. By performing the initialization portion earlier and not during the defined time period, a time needed to implement the active target process can be reduced as compared to performing both the initialization portion and the activate target portion during the defined time period. In an example, the defined time period can be a “customer maintenance window” during which one or more processes of the equipment are disabled or rendered inoperable for use.

According to some implementations, if a situation arises where one or more steps during the initialization portion should be reversed, one or more equipment can be reset to a previous configuration. Continuing the above example, during (or after) the third step, it is determined that an error or other condition has occurred that needs to be corrected. In this case, a reset process can be implemented with a single action (e.g., a single request). The request can be issued automatically by the network controller, based on a received request for the reset, or based on other internal and/or external determinations. The reset process causes the equipment can be reset to a previous state (e.g., step 2 in this example).

In an alternative or additional implementation, it might be determined that a situation or fatal error has occurred and the equipment should be restored to an original condition (e.g., respective conditions of the equipment before the initialization portion was performed). Accordingly, continuing the above example, if during (or after) one of the parallel initialization portions, or during (or after) the activate target portion, it is determined that the current process should be aborted, the equipment can be restored to their original configurations. This can be implemented via a restart process with a single action (e.g., a single request), which can be issued automatically by the network controller, based on a received request for the restart, or based on other internal and/or external determinations.

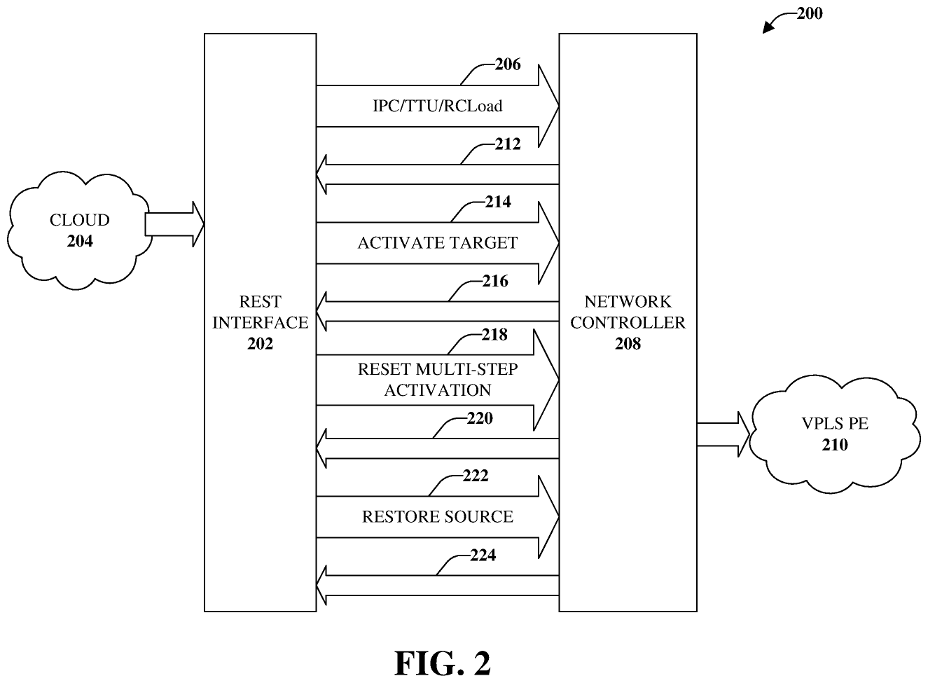

FIG. 2 illustrates an example, non-limiting, schematic representation 200 of activation and backout steps in accordance with one or more embodiments described herein. As illustrated, implementation of a Representational State Transfer interface (REST interface 202) can be facilitated via a cloud computing environment 204. The REST interface 202 can be associated with, or can be, a REST Application Program Interface (API), which can provide a set of rules that define how various applications or various devices can communicate and interact with one another. The REST interface 202 can facilitate performance of one or more steps of an initial activation 206 via a network controller 208.

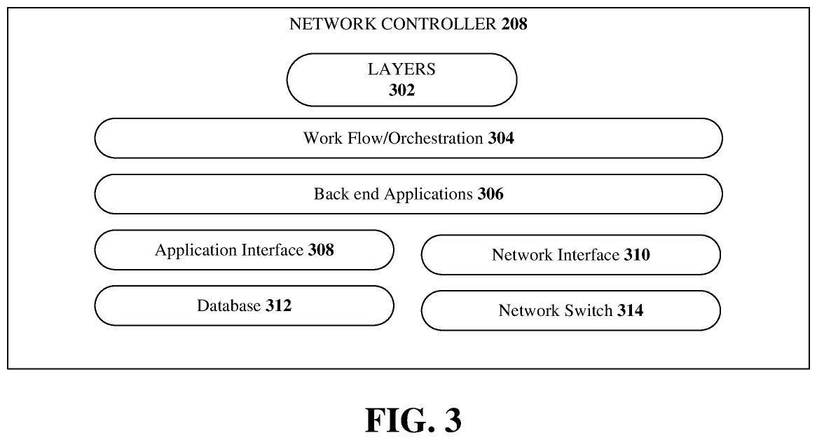

The network controller 208 can include various layers. For example, FIG. 3 illustrates an example, non-limiting, representation of layers 302 of the network controller 208 in accordance with one or more embodiments described herein. Layers 302 can include, but are not limited to, workflow/orchestration 304, backend applications 306, application interface 308, network interface 310, database 312, network switch 314.

For example, the initial activation or initialization portion can include Interprocess Communication (IPC), TTU, RCLoad, configure IP address, Virtual Routing and Forwarding (VRF), and so on. Such initialization portions can be decoupled from one another and can be initiated separately. For example, a first command can be to bring all equipment in one or more target networks (e.g., VLANs) from an initial state to an IPC state. The first command can be implemented, in parallel, across the equipment. To implement the first command in parallel, the first command is implemented on all the equipment at about the same time.

Upon or after the first command has been implemented, a second command can be initiated and implemented across the equipment in parallel. The parallel processing of the initial activation 206 can be performed while the equipment is on-line such as, for example, during one or more background processes. Such parallel processing of each step of the initial activation 206 is performed until all steps have completed across all network equipment.

As illustrated, to perform the parallel processing of the initial activation 206, the network controller 208 can communicate with the equipment via one or more virtual private LAN service provider edge routers (VPLS PEs 210). A consideration determined by the one or more embodiments herein is that the routers are able to process (or handle) the amount of traffic that is being communicated in order to perform the parallel configuration processes.

Upon or after implementation of each step of the initial activation 206, the network controller 208 sends, at 212, status updates to the REST interface 202. Further, once all the entire initial activation is completed, the REST interface is notified via a final status update of the status updates.

Upon or after completion of all steps of the initial activation 206 across the network equipment, an activate target portion 214 is performed. The activate target portion 214 can be performed during a customer maintenance window (or simply a maintenance window) during which the equipment and/or or subprocesses thereof, are brought offline. Upon or after the activate target portion 214 is completed, the network controller 208 provides information indicative of completion, as indicated at 216.

It is noted that the completion of the initial activation steps occur before the activate target portion is performed. For example, the initial activation steps can be completed hours, days, weeks, and so on, before the activate target portion. In such a manner, during the maintenance window, only the activate target portion is performed. This is in contrast to conventional methods that perform the initial activation steps including testing and activate target portion during the maintenance window. Accordingly, the disclosed embodiments can mitigate and/or reduce a time period associated with the maintenance window significantly (e.g., less than five minutes, less than ten minutes) as compared to conventional methods that can take forty-five minutes or more.

If a problem or error is discovered, a reset multi-step activation 218 command can be automatically sent to the network controller 208. The reset multi-step activation 218 can include instructions for resetting the equipment to a previous state or previous configuration. For example, if a problem is discovered during a third step of the initial activation, the reset multi-step activation 218 can restore the equipment back to the previous state (e.g., the second step of the initial activation in this example). As indicated at 220, the network controller 208 can confirm the reset has been applied to the equipment.

In some implementations, it might be determined that the initial state (or original state) of the equipment, before implementation of the one or more steps of the initial activation 206, should be restored. Accordingly, a restore source command 222 instructs the network controller 208 to restore the equipment to their respective original states. Confirmation of the restore is communicated to the REST interface 202, as indicated at 224.

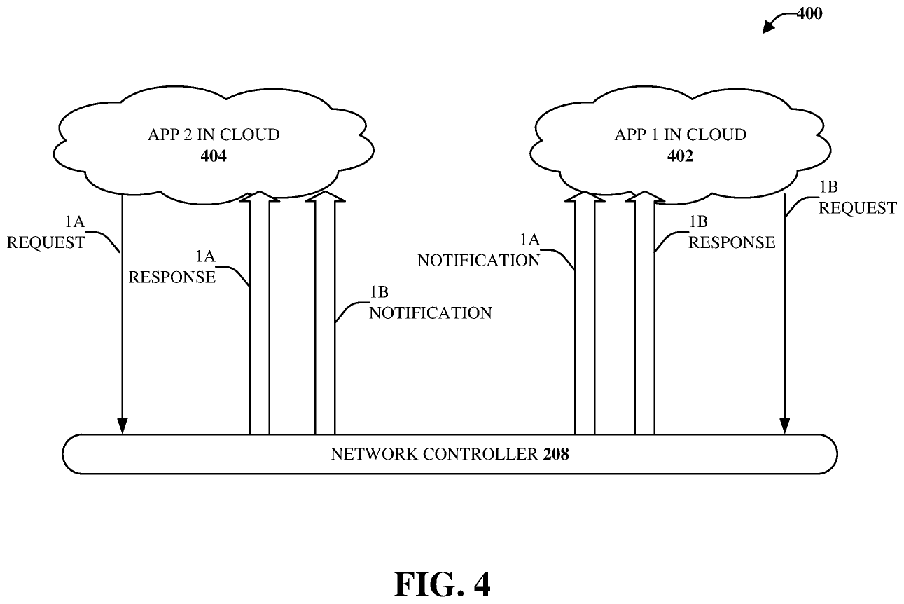

FIG. 4 illustrates a flow diagram 400 of a manual activation synchronization mechanism to enable hybrid activation in accordance with one or more embodiments described herein. Repetitive description of like elements employed in other embodiments described herein is omitted for sake of brevity.

Illustrated are two cloud computing environments including respective applications. For example, a first cloud computing environment can include a first application and a second cloud computing environment can include a second application. Also illustrated is the network controller 208, which is communicatively coupled to the first cloud computing environment and the second cloud computing environment.

The network controller 208 can determine that there is a situation where one or more equipment of a VLAN should be manually updated. For example, the situation can be an emergency situation and the equipment should be immediately updated, or updated as soon as possible, without waiting for automated updates as discussed herein. The details related to the manual configuration and/or an automatic configuration are transmitted between the first application and second application, as appropriate, in order for the status of the equipment to remain synchronized between the first application and the second application.

For purposes of explanation, the first cloud computing environment and first application will be discussed with respect to automatic configuration (e.g., an automated instantiation 402) and the second cloud computing environment and second application will be discussed with respect to manual configuration (e.g., a manual instantiation 404). Thus, when a manual configuration and/or automated configurations are performed the communication is synchronized between the applications (e.g., the first application and the second application). The synchronization can be based on various requests (e.g., 1B request, 1A request) for status updates of the equipment. The respective application can respond (e.g., 1B response, 1A response), which allows for synchronization. In some cases, the synchronization can occur automatically.

For example, upon or after a manual configuration is performed the manual instantiation 404 can automatically send a notification (1A notification) to the automated instantiation 402, via the network controller 208. In a similar manner, upon or after an automatic configuration is performed the automated instantiation 402 can automatically send a notification (1B notification) to the manual instantiation 404, via the network controller 208.

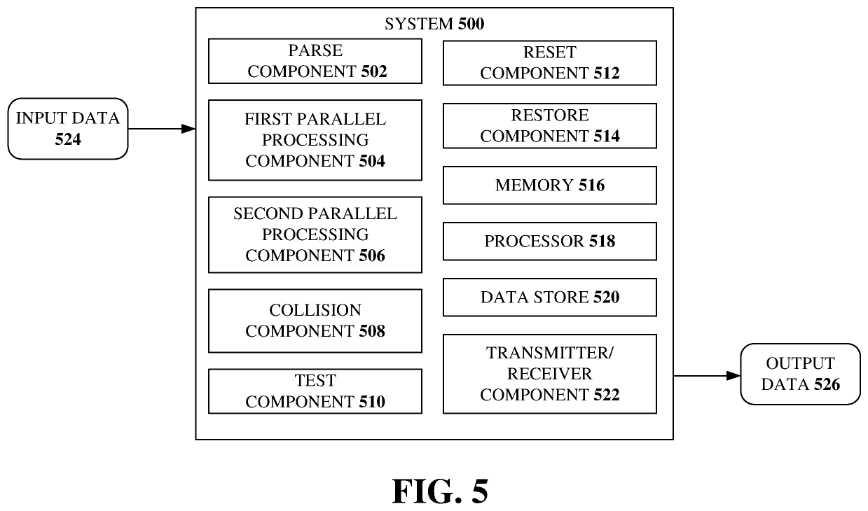

FIG. 5 illustrates an example, non-limiting, system 500 that facilitates multiple step network configuration activation automation based on parallel processing in accordance with one or more embodiments described herein. Repetitive description of like elements employed in other embodiments described herein is omitted for sake of brevity. The system 500 can be configured to perform functions associated with the computer-implemented method 100 of FIG. 1 and/or other computer-implemented methods discussed herein.

Aspects of systems (e.g., the system 500 and the like), apparatuses, and/or processes (e.g., computer-implemented methods) explained in this disclosure can include machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described. In various embodiments, the system 500 can be any type of component, machine, device, facility, apparatus, and/or instrument that can include a processor and/or can be capable of effective and/or operative communication with a wired and/or wireless network.

The system 500 can include a parse component 502, a first parallel processing component 504, a second parallel processing component 506, a collision component 508, a test component 510, a reset component 512, a restore component 514, at least one memory 516, at least one processor 518, at least one data store 520, and a transmitter/receiver component 522. In various embodiments, one or more of: the parse component 502, the first parallel processing component 504, the second parallel processing component 506, the collision component 508, the test component 510, the reset component 512, the restore component 514, the at least one memory 516, the at least one processor 518, the at least one data store 520, and the transmitter/receiver component 522 can be electrically and/or communicatively coupled to one another to perform one or more of the functions of the system 500. In some embodiments, one or more of: the parse component 502, the first parallel processing component 504, the second parallel processing component 506, the collision component 508, the test component 510, the reset component 512, the restore component 514, and the transmitter/receiver component 522 can include software instructions stored on the at least one memory 516 and/or the at least one data store 520 and executed by the at least one processor 518. The system 500 may also interact with other hardware and/or software components not depicted in FIG. 5.

The parse component 502 can receive (e.g., via the transmitter/receiver component 522) input data 524 that includes one or more instructions related to multiple step network configuration activation that is to be performed on target equipment. The target equipment can be, for example, VLAN equipment that are included in one or more VLANs. The input data can be received from another system (e.g., via the cloud computing environment 204 of FIG. 2).

A first group of initialization portion actions can be implemented via the first parallel processing component 504. For example, the first parallel processing component 504 can transmit output data 526 to the target equipment via, for example, one or more virtual private LAN service provider edge routers (e.g., the VPLS PEs 210 of FIG. 2). Implementation of the first group of initialization portion actions is performed by the first parallel processing component 504 during background processes and prior to an implementation period (e.g., maintenance window).

The initialization portion actions can include, but are not limited to, IPC, TTU, RCLoad, configure IP address, VRF collision detection, and so on. According to some implementations, to implement the first group of initialization portion actions the first parallel processing component 504 can identify the various steps of the initialization portion actions and determine an ordered list of actions associated with the initialization portion. Based on the ordered list, the first parallel processing component 504 can facilitate a first performance of a first action of the ordered list of actions on the equipment at substantially a first same time. Thus, the first action is performed at all of the equipment. Upon or after the first action has completed at all of the equipment, the first parallel processing component 504 can facilitate a second performance of a second action of the ordered list of actions on the equipment at substantially a second same time, different than the first same time. Upon or after completion of the second action at all of the equipment, the first parallel processing component 504 can facilitate a third action of the ordered list of actions across all of the equipment at substantially a third same time (different than the first same time and the second same time). This process can continue on subsequent actions of the ordered list of actions until all actions have been implemented.

Once all actions of the ordered list of actions are completed, active target actions can be scheduled for implementation during an implementation period (e.g., maintenance window). Thus, the second parallel processing component 506 can implement the second group of active target actions on the target equipment during the implementation period. Since the implementation period only includes the implementation of the active target actions, a period of time necessary for the implementation period can be minimal.

In some cases, collisions (e.g., VRF collisions) might exist, which can be determined by the collision component 508. For example, the collision component 508 can determine that collisions are expected to occur between first equipment and second equipment of the target equipment. In some cases, collisions can occur between more than two equipment, or different collisions can occur between various equipment. Based on the collisions, the collision component 508 can facilitate performance of the first group of initialization portion actions at the first equipment and the second equipment via sequential processing. Upon or after completion of the sequential processing, the first parallel processing component 504 can implement the first group of initialization portion actions by parallelizing bulk configurations of the first group of initialization portion actions for equipment of the target equipment for which collisions are avoided (e.g., for which collisions do not exist). In this example, the first parallel processing component 504 can implement the initialization portion on the other target equipment (e.g., other than the first equipment and the second equipment). In such a manner, collisions can be avoided while retaining benefits of parallel processing as discussed herein.

Prior to the second parallel processing component 506 implementing the second group of active target actions, the test component 510 can perform testing of the first group of initialization portion actions during background processes and prior to the implementation period. In some cases, the testing by the test component 510 can be performed during or after each action of the ordered list of actions are implemented by the first parallel processing component 504. In such a manner, testing is concluded prior to the implementation period, further mitigating an amount of time needed for the implementation period.

According to some implementations, an error or other issue might arise and equipment needs to be reset. Thus, the reset component 512 can, based on detection of an error associated with one or more equipment, reset a first current configuration of the one or more equipment to a previous configuration. For example, if at step five of the initialization portion a reset is needed, the one or more equipment can be reset to their respective conditions at step four. In some cases, other equipment might not be reset and can retain their current configuration. However, in some cases, all equipment might be reset by the reset component 512 via a single call or instruction.

The restore component 514 can facilitate returning the equipment to respective initial states. For example, a determination can be that the current network activation should be aborted. Thus, the restore component 514 can restore the target equipment to their respective initial states via a single call or instruction. The respective initial states are respective states of equipment of the target equipment prior to the implementing of the first group of initialization portion actions.

The system, as well as other embodiments discussed herein can determine a capacity of a server and determine whether to slow down the process or whether the process can be sped up. For example, there can be hundreds of VLANs and the system can determine the capacity the server is able to handle. For example, at a first time there might be 20 VLANs being updated per second. However, a network load on the server might increase and, therefore, the speed is reduced to 5 VLANs per second. This elasticity or scaling can be performed automatically by the system, which can throttle and send the information to the underlying applications, which implement the actual work.

Further, the system considers capability of one or more routers and differences between the routers (e.g., different configurations, different manufacturers, and so on). The consideration can include if the router can take the amount of parallelization being sent and, if not, the parallelization can be slowed down (e.g., reduce from x number of VLANs per second to y number of VLANs per second). Further, with respect to the different routers, the system can adhere to different rules associated with the different routers.

Further, the system determines a capacity of the network such that everything is not transmitted to the routers at the same time. Thus, the parallel processes and associated logic ensure that the network will not be overloaded based on implementation of appropriate corrective measures (e.g., slowing down the parallelization, dividing the VLANs into manageable subgroups and performing the parallelization on the manageable subgroups rather than on the VLANs at once, and so on).

Various advantages can be realized with the disclosed embodiments. For example, as discussed herein, multi-step network activation automation and parallelization is provided such that the activation occurs parallelly in a horizontal manner rather than in a vertical manner. For example, in the multi-step process (e.g., the initialization portion), without the disclosed embodiments each VLAN equipment would have steps implemented individually in a sequential order (e.g., step 1, then step 2, then step 3, and so on) prior to performing the activation on another VLAN equipment. However, with the disclosed embodiments, the individual steps are performed across all VLAN equipment at substantially the same time (e.g., in parallel). For example, step 1 is performed across all the VLAN equipment. Upon or after step 1 is completed, step 2 is performed across all the VLAN equipment, and so on. By performing the activation parallelly in a horizontal manner, the turn up time can be drastically reduced. Further, the disclosed embodiments also split or decouple the activate target process and multi-step activation process. Thus, the multi-step activation can be implemented in advance and can be tested before the customer maintenance window (e.g., the multi-step activation and testing is not performed during the maintenance window). Also, performing only the activate target during the maintenance window can mitigate and/or reduce an amount of time during which the VLAN equipment is off-line (e.g., instead of taking 45 minutes or more while the equipment is turned off, the activate target can be implemented in a few minutes with the disclosed embodiments). Due to this, a large number of circuits with larger number of VLANs can be turned up during the very stringent time restricted (e.g., 2-hour) customer maintenance window.

Further, instead of performing each VLAN multi-step activation (e.g., initial port configuration, test and turn up, RCLoad, and so on) manually from a Graphical User Interface (GUI), as discussed herein all VLANs can be activated automatically using just one REST call (e.g., a REST API).

Another advantage related to automation as discussed herein is that any collisions (e.g., VRF) are avoided during activation by sequencing the equipment that is subject to a collision and then performing parallel processing on the other equipment. Thus, the colliding equipment are activated sequentially while other equipment, not subject to collision, are activated in parallel. Thus, smart sensing and parallelizing is provided as discussed herein.

Another advantage is that all multi-step activation steps and testing can be performed prior to the target being activated during the customer maintenance window. Also, a reset of multistep activation of all VLANs can occur with just one reset call. According to some implementations, manual activation can be performed on one or more equipment and notifications are conveyed or transmitted between manual instances and automated instances such that external systems are synchronized.

Benefits of the disclosed embodiments include, but are not limited to, service is not out for a long time during circuit moves (e.g., maintenance window) saving revenue and facilitating a positive end-user experience. The equipment, such as user equipment, will no longer be required to go offline during service provider-initiated moves increasing end-user satisfaction. Large migration projects can be designed and implemented. For example, 10G migration and migration from third party providers can be performed effortlessly, which can mitigate and/or reduce implementation expenses. In case of test and turn up failures, the entire configuration can be restored to an original state by a single call. If one VLAN has an issue and needs manual intervention, the rest of the VLANs can still be processed using automation. VLAN multi step activation is achieved in a minimal amount of time during the maintenance window.

With continuing reference to FIG. 5, the at least one memory 516 can be operatively connected to the at least one processor 518. The at least one memory 516 and/or the at least one data store 520 can store executable instructions that, when executed by the at least one processor 518 can facilitate performance of operations. Further, the at least one processor 518 can be utilized to execute computer executable components stored in the at least one memory 516 and/or the at least one data store 520.

For example, the at least one memory 516 can store protocols associated with multiple step network configuration activation automation based on parallel processing as discussed herein. Further, the at least one memory 516 can facilitate action to control communication between the system 500, other apparatuses, other systems, equipment, network equipment, and/or user equipment associated with the categories under consideration, and so on, such that the system 500 can employ stored protocols and/or processes to facilitate load balancing of resources as described herein.

It should be appreciated that data stores (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically Programmable ROM (EPROM), Electrically Erasable ROM (EEPROM), or flash memory. Volatile memory can include Random Access Memory (RAM), which acts as external cache memory. By way of example and not limitation, RAM is available in many forms such as Synchronous RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DRRAM). Memory of the disclosed aspects are intended to include, without being limited to, these and other suitable types of memory.

The at least one processor 518 can facilitate respective deployment of parallel processing as discussed herein. The at least one processor 518 can be a processor dedicated to analyzing and/or generating information received, a processor that controls one or more components of the system 500, and/or a processor that both analyzes and generates information received and controls one or more components of the system 500.

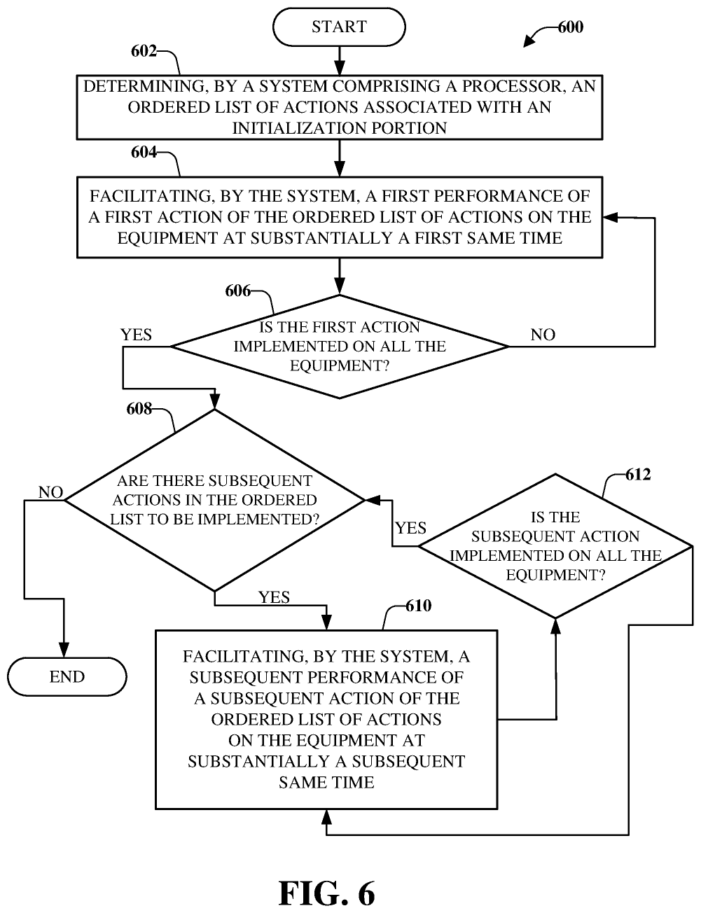

FIG. 6 illustrates an example, non-limiting, computer-implemented method 600 for facilitating parallel processing of initialization portions in accordance with one or more embodiments described herein. The computer-implemented method 600 can be implemented by a system including a memory and a processor, network equipment including a memory and a processor, a network controller including a memory and a processor, or another computer-implemented device including a memory and a processor.

The computer-implemented method 600 starts upon or after commands or instructions are received related to multiple step network configuration activation of one or more VLANs. Based on the commands or instructions at 602 an ordered list of actions associated with the initialization portion is determined. The initialization portion can be actions or steps that are to be performed prior to the configuration activation actually being implemented. The list of actions are ordered in an order of which they should be implemented.

Upon or after the ordered list is created, at 604, a first performance of a first action of the ordered list of actions can be performed on the equipment at substantially a first same time. The first same time is a first time period during which the first action is implemented across all equipment in a parallel manner, or substantially parallel manner.

A determination is made, at 606, whether the first action has been implemented across of the equipment. If not, the computer-implemented method 600 returns to 604 to allow more time for the implementation of the first actions (e.g., more time might be needed if conflicts or collisions exist, if testing needs to be conducted, and so on). If the first action has been implemented on all the equipment (“YES”), another determination is made, at 608, whether there are one or more subsequent actions of the initial actions to be implemented on the equipment. The subsequent actions can be a second action, a third action, a fourth action, a fifth action, and so on.

If there are no other actions in the ordered list (“NO”), the computer-implemented method 600 ends. Alternatively, if the determination at 608 is that there is at least one subsequent action to be implemented, at 610, a subsequent action of the ordered list of actions on the equipment is performed at a subsequent same time. Thus, for example, a second performance of a second action of the ordered list of actions is implemented on the equipment at substantially a second same time, different than the first same time. The second same time is a second time period (after the first time period) during which the second action is implemented across all equipment in a parallel manner, or substantially parallel manner.

A determination is made, at 612, whether the subsequent action has been implemented across of the equipment. If not, the computer-implemented method 600 returns to 610 to allow more time for the implementation of the subsequent actions (e.g., more time might be needed if conflicts or collisions exist, if testing needs to be conducted, and so on). If the determination at 612 is that the implementation of the subsequent action is complete, the computer-implemented method 600 returns to 608 and another determination is made whether there are any other subsequent actions to be implemented. It is noted that the determination at 608, the action at 610, and the determination at 612 can be recursive such that the computer-implemented method 600 can process any number of subsequent determinations and subsequent actions until all actions of the ordered list have been successfully implemented at all the equipment.

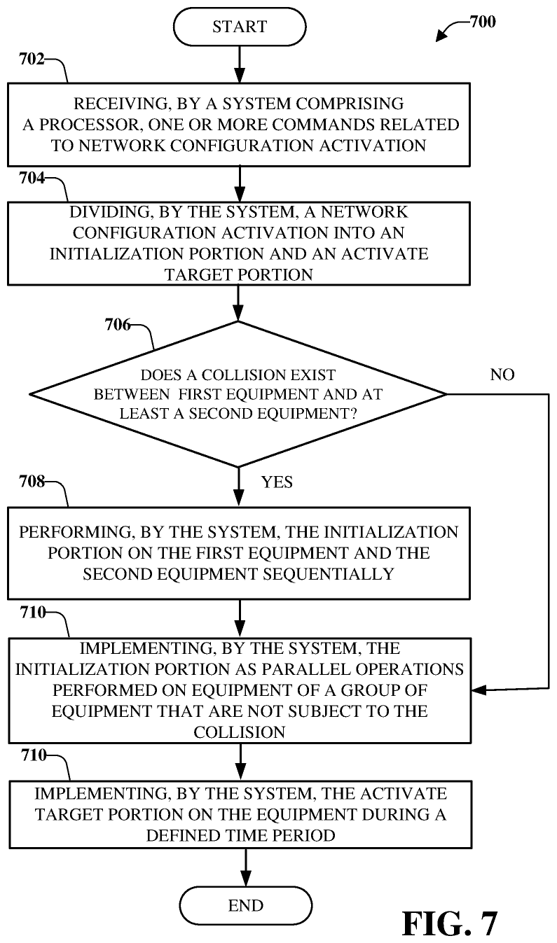

FIG. 7 illustrates an example, non-limiting, computer-implemented method 700 for facilitating sequential and parallel processing based on detection of collisions in accordance with one or more embodiments described herein. The computer-implemented method 700 can be implemented by a system including a memory and a processor, network equipment including a memory and a processor, a network controller including a memory and a processor, or another computer-implemented device including a memory and a processor.

At 702, one or more commands related to network configuration activation are received. Based on the one or more commands, at 704, a network configuration activation is divided into an initialization portion and an active target process. For example, the initialization portion can include multiple steps and/or procedures to be performed in order to implement an activation configuration(s) on a group of equipment. The activate target portion can be an update or configuration that is applied at the group of equipment. The group of equipment can be equipment associated with one or more VLANs. Dividing the network configuration activation can be based on one or more instructions received that indicate the configuration activation is to be performed on the group of network equipment.

A determination is made, at 706, whether a collision exists between equipment (e.g., between a first equipment and at least a second equipment). According to some implementations, the collision can be a VRF collision. If a collision does exist (“YES”), at 708, the initialization portion is performed on the first equipment and at least the second equipment sequentially. For example, the initialization portion can be executed on the first equipment and upon or after completion at the first equipment, the initialization portion can be executed on the second equipment. If there are other equipment that are subject to a collision, the other equipment can also be updated with the initialization portion in a sequential matter.

Upon or after the sequential updates to the first equipment, the second equipment, and/or other equipment, or if the determination at 706 is that there are no conflicts (“NO”), at 710, the initialization portion is implemented as parallel operations on the equipment that are not subject to the collision(s). Therefore, sequential implementation and parallel implementation can be performed based on one or more conflicts. By way of example and not limitation, there are ten devices numbered from 1 through 10 and it is determined that a conflict (or more than one conflict) exists between device 3, device 6, and device 9. Thus, sequential processing will be performed on the three devices in any determined order (e.g., device 6 is updated, then device 3 is updated, then device 9 is updated). After the three devices with the conflict are updated sequentially, parallel processing can be performed on the other devices (e.g., device 1, device 2, device 4, device 5, device 7, device 8, and device 10). Upon or after the initialization portion is completed for all equipment, at 712, the activate target portion is implemented on the equipment during a defined time period. Implementation of the initialization portion (both sequentially and in parallel) is performed during background processes and prior to the defined time period.

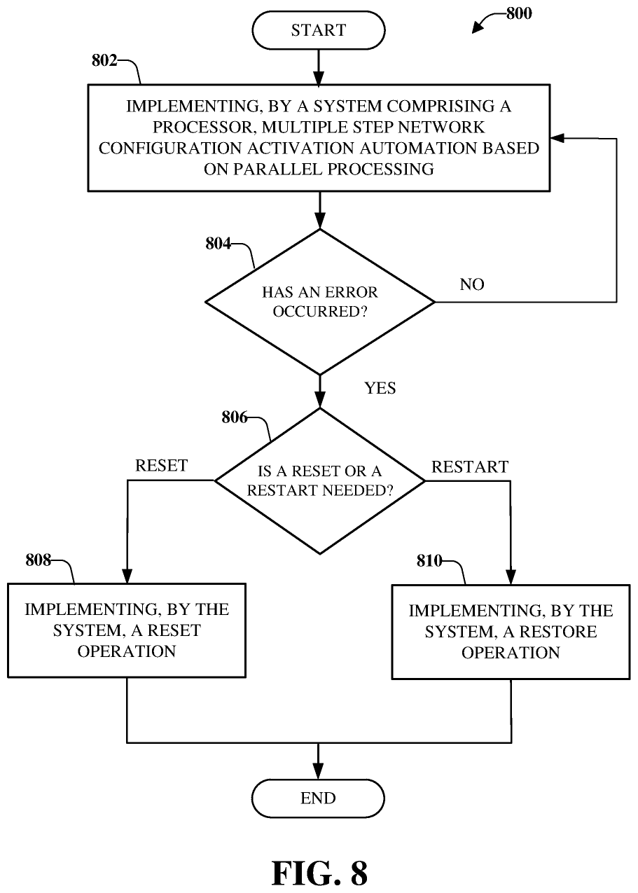

FIG. 8 illustrates an example, non-limiting, computer-implemented method 800 for resetting and/or restoring equipment during multiple step network configuration activation automation based on parallel processing in accordance with one or more embodiments described herein. The computer-implemented method 800 can be implemented by a system including a memory and a processor, network equipment including a memory and a processor, a network controller including a memory and a processor, or another computer-implemented device including a memory and a processor.

At 802, a multiple step network configuration activation automation based on parallel processing is implemented. During the implementation process, a determination is made, at 804, whether an error has occurred. In an error has not occurred (“NO”) the method can continue at 802. However, if an error has occurred (“YES”), at 806, a determination is made whether a reset or a restore is needed. The reset is needed if the error involves one or more steps of initial actions of the configuration activation. In an example, the reset error can be an implementation error of an initial action, a test procedure ran on the equipment has failed, and so on. However, if the error is a major error (or fatal error), then the equipment should be returned to initial or original states prior to the implementation of the configuration activation.

Thus, if it is determined a reset is needed, at 808 a reset operation (e.g., a backout mechanism) is implemented. The reset operation can automatically reset one or more equipment to a previous state. For example, if the initial actions include 17 individual actions (sorted in an ordered list from action 1 to 17), and an error is detected with respect to action 10 at one or more equipment (or at all equipment), the reset process can set the one or more equipment (or all the equipment) to a previous state, which is the state at action 9 in this example. In this case, a reset process can be implemented with a single action (e.g., a single request) and the equipment can be reset to a previous state. The reset process can be requested automatically by the network controller, based on a received request for the reset, or based on other internal and/or external determinations.

Alternatively, if it is determined at 806 that a restore (e.g., a backout mechanism) is needed, at 810, a restore operation is implemented. For example, there might be a situation or fatal error and the equipment should be restored to an original condition (e.g., respective conditions of the equipment before the initial activation steps were performed). Accordingly, the current process should be aborted, and the equipment can be restored to their original configurations. This can be implemented via a restart process with a single action (e.g., a single request). The request can be initiated automatically by the network controller, based on a received request for the restart, or based on other internal and/or external determinations.

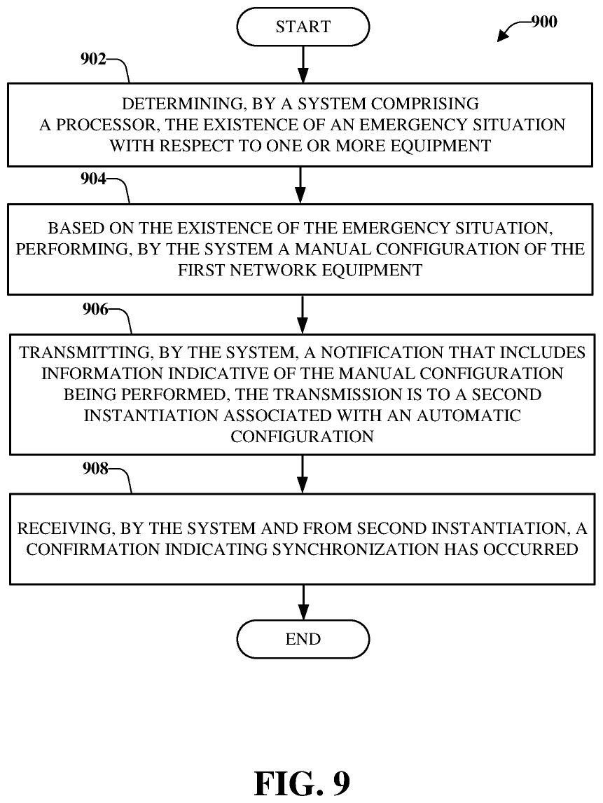

FIG. 9 illustrates an example, non-limiting, computer-implemented method 900 for performing manual and automated procedures during multiple step network configuration activation in accordance with one or more embodiments described herein. The computer-implemented method 900 can be implemented by a system including a memory and a processor, network equipment including a memory and a processor, a network controller including a memory and a processor, or another computer-implemented device including a memory and a processor.

In some implementations, there might be a situation where 2 VLANs out of 100 VLANs are to be activated. Thus, those 2 VLANs can be activated manually since those 2 VLANs are determined to be important and each step occurring should be monitored. Even though the 2 VLANs are updated manually, it does not hinder the other 98 VLANs from being updated automatically. Thus, there should be synchronization between the manual processes and the automatic processes based on notifications.

The computer-implemented method 900 starts, at 902, when the existence of an emergency situation with respect to one or more equipment is determined. In an example, the emergency situation can be a configuration issue, however, the emergency situation is not limited to a configuration issue. The existence of the emergency situation can result in the need to update at least a subset of the equipment manually.

For purposes of explanation, the emergency situation will be discussed with respect to a first equipment. However, in some implementations there may be an emergency situation on multiple devices, different emergency situations associated with different equipment, or combinations thereof. Further, in some cases, two or more emergency situations might occur at a same time, at different times, or combinations thereof.

Based on the existence of the emergency situation, at 904, a manual configuration of the first network equipment is performed. For example, the manual configuration can be performed based on a first instantiation of a manual configuration (e.g., a manual application implemented via a cloud computing environment). Performing the manual configuration can include transmitting at 906, a notification that includes information indicative of the manual configuration being performed, to a second instantiation associated with an automatic configuration (e.g., an automatic application implemented via a cloud computing environment).

A response to the notification can be received, at 908. The response can be received from the second instantiation, which confirms receipt of the notification transmitted at 906. In a similar manner, as automatic updates are being performed by the second instantiation, the first instantiation (e.g., manual process) can be notified. As such, both the manual process (e.g., first instantiation) and the automatic process (e.g., second instantiation) can update internal registers or internal databases that monitor and track status of the equipment of one or more VLANs.

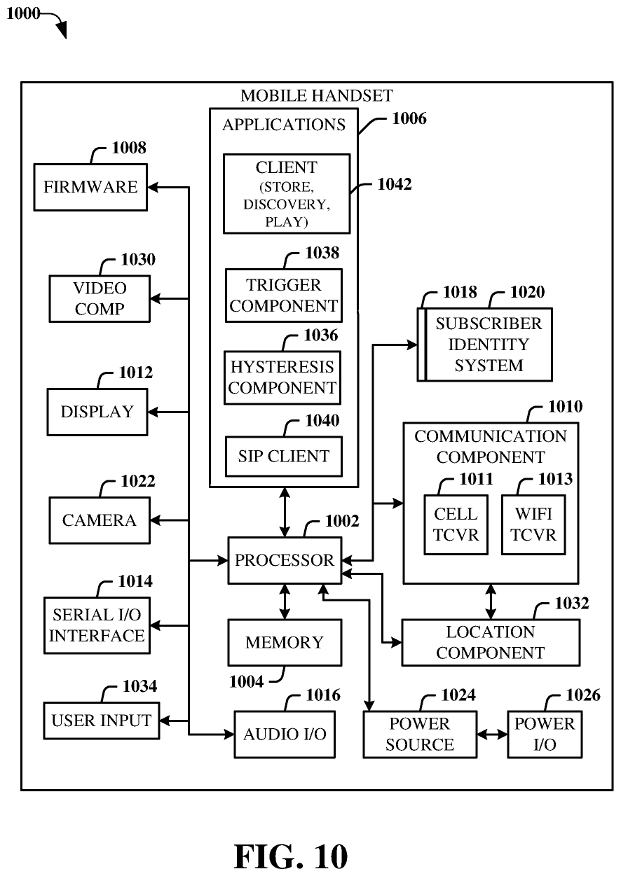

Described herein are systems, methods, articles of manufacture, non-transitory machine-readable medium, and other embodiments or implementations that can facilitate multiple step network configuration activation automation based on parallel processing. Referring now to FIG. 10, illustrated is an example, non-limiting, block diagram of a handset 1000 operable to engage in a system architecture that facilitates wireless communications according to one or more embodiments described herein. Although a mobile handset is illustrated herein, it will be understood that other devices can be a mobile device, and that the mobile handset is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information, and which can be accessed by the computer.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset includes a processor 1002 for controlling and processing all onboard operations and functions. A memory 1004 interfaces to the processor 1002 for storage of data and one or more applications 1006 (e.g., a video player software, user feedback component software, etc.). Other applications can include voice recognition of predetermined voice commands that facilitate initiation of the user feedback signals. The applications 1006 can be stored in the memory 1004 and/or in a firmware 1008, and executed by the processor 1002 from either or both the memory 1004 or/and the firmware 1008. The firmware 1008 can also store startup code for execution in initializing the handset 1000. A communications component 1010 interfaces to the processor 1002 to facilitate wired/wireless communication with external systems, e.g., cellular networks, VoIP networks, and so on. Here, the communications component 1010 can also include a suitable cellular transceiver 1011 (e.g., a GSM transceiver) and/or an unlicensed transceiver 1013 (e.g., Wi-Fi, WiMax) for corresponding signal communications. The handset 1000 can be a device such as a cellular telephone, a PDA with mobile communications capabilities, and messaging-centric devices. The communications component 1010 also facilitates communications reception from terrestrial radio networks (e.g., broadcast), digital satellite radio networks, and Internet-based radio services networks.

The handset 1000 includes a display 1012 for displaying text, images, video, telephony functions (e.g., a Caller ID function), setup functions, and for user input. For example, the display 1012 can also be referred to as a “screen” that can accommodate the presentation of multimedia content (e.g., music metadata, messages, wallpaper, graphics, etc.). The display 1012 can also display videos and can facilitate the generation, editing and sharing of video quotes. A serial I/O interface 1014 is provided in communication with the processor 1002 to facilitate wired and/or wireless serial communications (e.g., USB, and/or IEEE 1394) through a hardwire connection, and other serial input devices (e.g., a keyboard, keypad, and mouse). This can support updating and troubleshooting the handset 1000, for example. Audio capabilities are provided with an audio I/O component 1016, which can include a speaker for the output of audio signals related to, for example, indication that the user pressed the proper key or key combination to initiate the user feedback signal. The audio I/O component 1016 also facilitates the input of audio signals through a microphone to record data and/or telephony voice data, and for inputting voice signals for telephone conversations.

The handset 1000 can include a slot interface 1018 for accommodating a SIC (Subscriber Identity Component) in the form factor of a card Subscriber Identity Module (SIM) or universal SIM 1020, and interfacing the SIM card 1020 with the processor 1002. However, it is to be appreciated that the SIM card 1020 can be manufactured into the handset 1000, and updated by downloading data and software.

The handset 1000 can process IP data traffic through the communications component 1010 to accommodate IP traffic from an IP network such as, for example, the Internet, a corporate intranet, a home network, a person area network, etc., through an ISP or broadband cable provider. Thus, VoIP traffic can be utilized by the handset 1000 and IP-based multimedia content can be received in either an encoded or decoded format.

A video processing component 1022 (e.g., a camera) can be provided for decoding encoded multimedia content. The video processing component 1022 can aid in facilitating the generation, editing, and sharing of video quotes. The handset 1000 also includes a power source 1024 in the form of batteries and/or an AC power subsystem, which power source 1024 can interface to an external power system or charging equipment (not shown) by a power 110 component 1026.

The handset 1000 can also include a video component 1030 for processing video content received and, for recording and transmitting video content. For example, the video component 1030 can facilitate the generation, editing and sharing of video quotes. A location tracking component 1032 facilitates geographically locating the handset 1000. As described hereinabove, this can occur when the user initiates the feedback signal automatically or manually. A user input component 1034 facilitates the user initiating the quality feedback signal. The user input component 1034 can also facilitate the generation, editing and sharing of video quotes. The user input component 1034 can include such conventional input device technologies such as a keypad, keyboard, mouse, stylus pen, and/or touchscreen, for example.

Referring again to the applications 1006, a hysteresis component 1036 facilitates the analysis and processing of hysteresis data, which is utilized to determine when to associate with the access point. A software trigger component 1038 can be provided that facilitates triggering of the hysteresis component 1036 when the Wi-Fi transceiver 1013 detects the beacon of the access point. A SIP client 1040 enables the handset 1000 to support SIP protocols and register the subscriber with the SIP registrar server. The applications 1006 can also include a client 1042 that provides at least the capability of discovery, play and store of multimedia content, for example, music.

The handset 1000, as indicated above related to the communications component 1010, includes an indoor network radio transceiver 1013 (e.g., Wi-Fi transceiver). This function supports the indoor radio link, such as IEEE 802.11, for a dual-mode GSM handset. The handset 1000 can accommodate at least satellite radio services through a handset that can combine wireless voice and digital radio chipsets into a single handheld device.

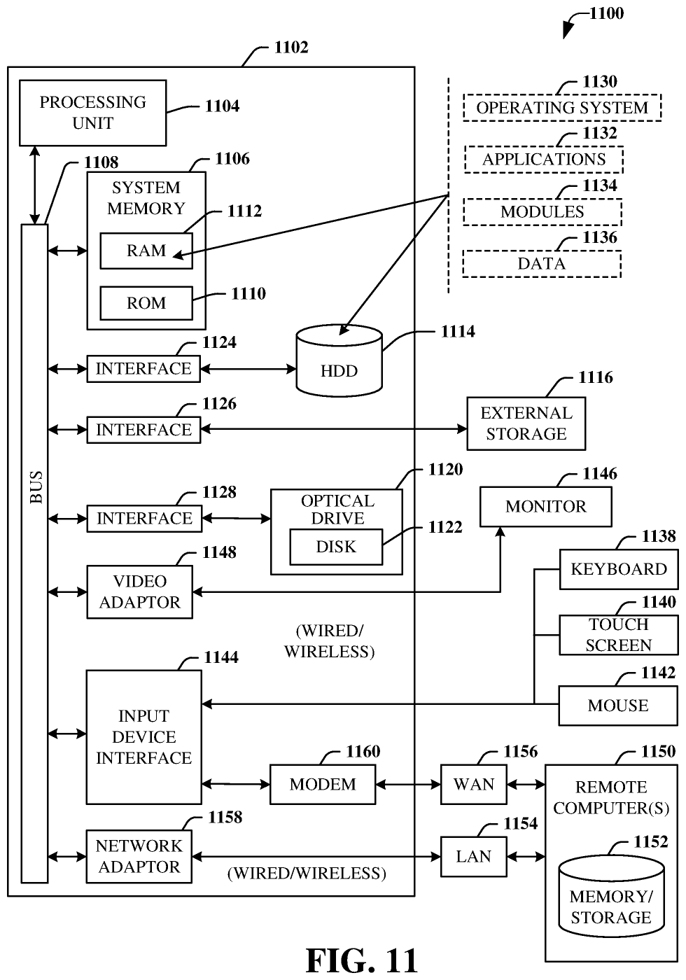

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A Basic Input/Output System (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and a drive 1120, e.g., such as a solid state drive, an optical disk drive, which can read or write from a disk 1122, such as a CD-ROM disc, a DVD, a BD, etc. Alternatively, where a solid state drive is involved, disk 1122 would not be included, unless separate. While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and drive 1120 can be connected to the system bus 1108 by an HDD interface 1124, an external storage interface 1126 and a drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally include emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can include one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For example, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above, such as but not limited to a network virtual machine providing one or more aspects of storage or processing of information. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

An aspect of 5G, which differentiates from previous 4G systems, is the use of NR. NR architecture can be designed to support multiple deployment cases for independent configuration of resources used for RACH procedures. Since the NR can provide additional services than those provided by LTE, efficiencies can be generated by leveraging the pros and cons of LTE and NR to facilitate the interplay between LTE and NR, as discussed herein.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” and the like are intended to refer to, or can include a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device,” “user equipment” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

The various aspects described herein can relate to New Radio (NR), which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, 6G, a UMTS implementation, and/or an LTE implementation as the techniques can also be applied in 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

As used herein, “5G” can also be referred to as NR access. Accordingly, systems, methods, and/or machine-readable storage media for facilitating link adaptation of downlink control channel for 5G systems are desired. As used herein, one or more aspects of a 5G network can include, but is not limited to, data rates of several tens of megabits per second (Mbps) supported for tens of thousands of users; at least one gigabit per second (Gbps) to be offered simultaneously to tens of users (e.g., tens of workers on the same office floor); several hundreds of thousands of simultaneous connections supported for massive sensor deployments; spectral efficiency significantly enhanced compared to 4G; improvement in coverage relative to 4G; signaling efficiency enhanced compared to 4G; and/or latency significantly reduced compared to LTE.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification procedures and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
dividing, by a system comprising a processor, a network configuration activation into an initialization portion and an activate target portion;
implementing, by the system, the initialization portion as parallel operations performed on equipment of a group of equipment; and
implementing, by the system, the activate target portion on the equipment during a defined time period, wherein the implementing of the initialization portion is performed during background processes and prior to the defined time period.

2. The method of claim 1, wherein the implementing of the initialization portion as the parallel operations comprises:
determining an ordered list of actions associated with the initialization portion;
facilitating a first performance of a first action of the ordered list of actions on the equipment at substantially a first same time; and
based on a determination that the facilitating of the first performance is completed, facilitating a second performance of a second action of the ordered list of actions on the equipment at substantially a second same time, different than the first same time.

3. The method of claim 1, wherein the equipment comprise a first equipment and a second equipment, and wherein the method further comprises:
prior to the implementing of the initialization portion as the parallel operations, determining, by the system, a virtual routing and forwarding collision exists between the first equipment and the second equipment; and
performing, by the system, the initialization portion on the first equipment and the second equipment sequentially.

4. The method of claim 1, wherein the equipment comprise a first equipment and a second equipment, and wherein the method further comprises:
based on detection of an error associated with the first equipment, resetting, by the system, a first current configuration of the first equipment to a previous configuration, wherein the second equipment retains a second current configuration.

5. The method of claim 1, further comprising:
based on detection of an error, restoring, by the system, the equipment to respective initialization portions, wherein the respective initialization portions are respective configurations of the equipment prior to the implementing of the activate target portion.

6. The method of claim 1, wherein the implementing of the initialization portion as the parallel operations is performed while the equipment are in an on-line status.

7. The method of claim 1, further comprising:
determining, by the system, that first equipment of the equipment has encountered a configuration issue; and
facilitating, by the system, a manual configuration of the first equipment, wherein other equipment, excluding the first equipment, are configured via an automated configuration.

8. The method of claim 7, wherein the manual configuration is implemented via a first instantiation, wherein the automated configuration is implemented via a second instantiation, and wherein the method further comprises:
facilitating, by the system, a first transmission of a first notification from the first instantiation to the second instantiation, wherein the first notification comprises first information indicative of the manual configuration of the first equipment.

9. The method of claim 8, further comprising:
facilitating, by the system, a second transmission of a second notification from the second instantiation to the first instantiation, wherein the second notification comprises second information indicative of the automated configuration of the other equipment.

10. The method of claim 1, wherein the group of equipment are associated with a virtual local area network.

11. A system, comprising:
a processor; and
a memory that stores executable instructions that, when executed by the processor, facilitate performance of operations, comprising:
based on a determination that a network activation is to be implemented on target equipment, parsing the network activation into a first group of initialization portion actions and a second group of active target actions;
implementing, via first parallel processing, the first group of initialization portion actions on the target equipment; and
based on a second determination of a completion of the implementing of the first group of initialization portion actions, implementing, via second parallel processing, the second group of active target actions on the target equipment during an implementation period.

12. The system of claim 11, wherein the implementing of the first group of initialization portion actions is performed during background processes and prior to the implementation period.

13. The system of claim 11, wherein the implementing of the first group of initialization portion actions comprises parallelizing bulk configurations of the first group of initialization portion actions for equipment of the target equipment for which collisions are avoided.

14. The system of claim 13, wherein the equipment is first equipment, and wherein the operations further comprise:
determining that collisions are expected to occur between the first equipment and second equipment of the target equipment; and
performing initialization portion actions of the first group of initialization portion actions at the first equipment and the second equipment via sequential processing.

15. The system of claim 11, wherein the operations further comprise:
based on a third determination that the implementing of the first group of initialization portion actions is to be aborted, restoring the target equipment to respective initial states, wherein the respective initial states are respective states of equipment of the target equipment prior to the implementing of the first group of initialization portion actions.

16. The system of claim 11, wherein the operations further comprise:
prior to the implementing of the second group of active target actions, performing testing of the first group of initialization portion actions during background processes and prior to the implementation period.

17. The system of claim 11, wherein the target equipment are equipment of a virtual local area network.

18. A non-transitory machine-readable medium, comprising executable instructions that, when executed by a processor, facilitate performance of operations, comprising:
decoupling a configuration of a group of target equipment into a first group of initial events and a second group of implementation events;
performing the first group of initial events via first parallel processing across the group of target equipment and during background processes; and
performing the second group of implementation events via second parallel processing across the group of target equipment and during a defined period reserved for the second group of implementation events, wherein the performing of the first group of initial events is completed prior to the defined period.

19. The non-transitory machine-readable medium of claim 18, wherein the first parallel processing comprises:
implementing a first initial event of the first group of initial events on the group of target equipment during a first time period; and
based on a determination that the implementing the first group of initial events has finalized, implementing a second initial event of the first group of initial events on the group of target equipment during a second time period.

20. The non-transitory machine-readable medium of claim 18, wherein the defined period is a maintenance window, and wherein the group of target equipment is off-line during the defined period.
